(19) United States
(12) Patent Application Publication
(10) Pub. No.: US 2026/0335789 A1
(43) Pub. Date: Oct. 29, 2026

(54) METHOD AND APPARATUS FOR INJECTING ELECTROLYTE BASED ON DEGASSING

(71) Applicant: SK ON CO., LTD., Seoul (KR)

(72) Inventor: Do Gyeong HA, Daejeon (KR)

(21) Appl. No.: 19/656,924

(22) Filed: Apr. 23, 2026

(30) Foreign Application Priority Data
Apr. 29, 2025 (KR) 10-2025-0056629

(51) Int. Cl. B01D 19/00; H01M 50/618; H01M 50/673

(52) U.S. Cl. CPC B01D 19/0073; B01D 19/0068; H01M 50/618; H01M 50/673; B01D 2257/102; B01D 2259/10; B01D 2259/45

(57) ABSTRACT

An apparatus and a method for injecting an electrolyte based on degassing are provided. The apparatus depressurizes a tank into which an electrolyte is injected to a first pressure, transfers the nitrogen-pressurized electrolyte to a first hopper by pressurizing the tank to a second pressure with nitrogen in the depressurized state, transfers the nitrogen-pressurized electrolyte to a second hopper inside a chamber depressurized to a third pressure, increases a pressure inside the chamber to a fourth pressure equal to or higher than an atmospheric pressure, completes injection of the electrolyte into a cell inside the chamber, and heats the electrolyte in the tank or the first hopper to a target temperature based on vapor pressures of respective components of the electrolyte.

### CROSS-REFERENCE TO RELATED APPLICATION

This application claims priority to Korean Patent Application No. 10-2025-0056629 filed Apr. 29, 2025, the disclosure of which is hereby incorporated by reference in its entirety.

### BACKGROUND

### Technical Field

The present disclosure relates to a method and apparatus for injecting an electrolyte based on degassing, and more particularly, to a method and apparatus for removing gas from an electrolyte and injecting the degassed electrolyte into a cell.

### Technical Considerations

In the process of manufacturing batteries such as lithium-ion batteries and fuel cells, the process of injecting an electrolyte into an electrode plays a critical role in determining battery performance. Specifically, the porous structure of the electrode must be sufficiently impregnated with the electrolyte to secure optimal ionic conductivity, and it is crucial to minimize the interfacial resistance between the electrode and the electrolyte.

Generally, in the electrolyte injection process, a method of repeatedly applying vacuum and pressure after injecting the electrolyte under a vacuum environment is primarily used to evenly impregnate the electrolyte into the pores of the electrode. This process is designed to remove gas present in the pores within the electrode and induce the electrolyte to penetrate deeply into the pores. However, this repetitive vacuum and pressurization process requires a significant amount of time, and it is difficult to ensure uniform impregnation.

Furthermore, commonly supplied electrolytes are typically used without undergoing any specific pretreatment process, and thus are introduced containing a large amount of dissolved gas. The dissolved gas remaining in the electrolyte mixes with existing gas inside the electrode pores to form fine bubbles. This not only decreases the penetration rate of the electrolyte but may also lead to poor contact between the electrode and the electrolyte. Particularly, if bubbles remain inside the electrode, local ionic conductivity is reduced, which causes degradation of battery performance.

### SUMMARY

Embodiments of the present disclosure may provide a method for injecting an electrolyte based on degassing.

According to an embodiment of the present disclosure, there is provided a method for injecting an electrolyte based on degassing, comprising: depressurizing a tank into which an electrolyte is injected to a first pressure; transferring, by pressurizing the tank to a second pressure with nitrogen in the depressurized state, the nitrogen-pressurized electrolyte to a first hopper; transferring the nitrogen-pressurized electrolyte to a second hopper inside a chamber depressurized to a third pressure; increasing a pressure inside the chamber to a fourth pressure equal to or higher than an atmospheric pressure; completing injection of the electrolyte into a cell inside the chamber; and heating the electrolyte in the tank or the first hopper to a target temperature based on vapor pressures of respective components of the electrolyte.

In some non-limiting embodiments or aspects, the target temperature is a temperature set such that a vapor pressure of a component having a highest vapor pressure among components included in the electrolyte is less than the first pressure.

In some non-limiting embodiments or aspects, the heating of the electrolyte comprises heating the electrolyte to reach the target temperature using a storage container heating method or an electrolyte heating method.

In some non-limiting embodiments or aspects, the second pressure is an atmospheric pressure or a preset value equal to or greater than 100 kPa.

In some non-limiting embodiments or aspects, the transferring of the nitrogen-pressurized electrolyte to the first hopper comprises transferring the electrolyte in the tank to the first hopper using a metering pump or a mass flow controller.

In some non-limiting embodiments or aspects, the increasing of the pressure inside the chamber comprises pressurizing the chamber with nitrogen to increase the pressure inside the chamber to a preset fifth pressure exceeding the fourth pressure.

In some non-limiting embodiments or aspects, the method further comprises depressurizing the first hopper to a sixth pressure higher than the third pressure upon completion of the transfer of the electrolyte, prior to transferring the nitrogen-pressurized electrolyte to the second hopper.

In some non-limiting embodiments or aspects, the heating of the electrolyte comprises controlling the target temperature or a heating time such that a dissolved gas concentration of the electrolyte injected into the tank is equal to or less than a preset value.

In some non-limiting embodiments or aspects, the tank comprises two or more tanks, and the transferring of the nitrogen-pressurized electrolyte to the first hopper comprises alternately transferring the electrolyte in the two or more tanks to the first hopper.

In some non-limiting embodiments or aspects, the method further comprises pressurizing the second hopper with nitrogen after transferring the nitrogen-pressurized electrolyte to the second hopper inside the chamber depressurized to the third pressure.

In some non-limiting embodiments or aspects, the first pressure is set to -70 kPa, and the third pressure is set to -95 kPa.

According to another embodiment, there is provided an apparatus for injecting an electrolyte based on degassing, comprising: a tank for controlling a temperature and a pressure of an electrolyte; a first hopper for transferring the electrolyte; a cell into which the electrolyte is injected; a chamber for controlling a pressure of the cell; a second hopper inside the chamber for injecting the electrolyte; and a controller configured to: depressurize the tank into which the electrolyte is injected to a first pressure; transfer, by pressurizing the tank to a second pressure with nitrogen in the depressurized state, the nitrogen-pressurized electrolyte to the first hopper; transfer the nitrogen-pressurized electrolyte to the second hopper inside the chamber depressurized to a third pressure; increase a pressure inside the chamber to a fourth pressure equal to or higher than an atmospheric pressure; complete injection of the electrolyte into the cell inside the chamber; and heat the electrolyte in the tank or the first hopper to a target temperature based on vapor pressures of respective components of the electrolyte.

In some non-limiting embodiments or aspects, the target temperature is a temperature set such that a vapor pressure of a component having a highest vapor pressure among components included in the electrolyte is less than the first pressure.

In some non-limiting embodiments or aspects, the controller is configured to heat the electrolyte to reach the target temperature using a storage container heating method or an electrolyte heating method.

In some non-limiting embodiments or aspects, the second pressure is an atmospheric pressure or a preset value equal to or greater than 100 kPa.

In some non-limiting embodiments or aspects, the controller is configured to transfer the electrolyte in the tank to the first hopper using a metering pump or a mass flow controller.

In some non-limiting embodiments or aspects, the controller is configured to pressurize the chamber with nitrogen to increase the pressure inside the chamber to a preset fifth pressure exceeding the fourth pressure.

In some non-limiting embodiments or aspects, the controller is configured to depressurize the first hopper to a sixth pressure higher than the third pressure upon completion of the transfer of the electrolyte.

In some non-limiting embodiments or aspects, the controller is configured to control the target temperature or a heating time such that a dissolved gas concentration of the electrolyte injected into the tank is equal to or less than a preset value.

In some non-limiting embodiments or aspects, the tank comprises two or more tanks, and the controller is configured to alternately transfer the electrolyte in the two or more tanks to the first hopper.

In some non-limiting embodiments or aspects, the controller is configured to pressurize the second hopper with nitrogen after transferring the nitrogen-pressurized electrolyte to the second hopper inside the chamber depressurized to the third pressure.

In some non-limiting embodiments or aspects, the first pressure is set to -70 kPa, and the third pressure is set to -95 kPa.

In some non-limiting embodiments, by performing a degassing process before injecting the electrolyte to remove a dissolved gas in the electrolyte, bubble formation that may occur inside a battery cell may be minimized, performance degradation of the battery cell may be prevented by allowing the electrolyte to diffuse uniformly within the cell, and contact resistance between an electrode and the electrolyte may be reduced.

In some non-limiting embodiments, by monitoring a state of the electrolyte before and after injection in real time and precisely controlling a pressure change during an injection process to enable uniform filling of the electrolyte, scattering due to an excessive pressure difference during the injection of the electrolyte may be prevented, and performance degradation of the battery due to non-uniform filling of the electrolyte may be prevented.

In some non-limiting embodiments, by precisely adjusting a pressure balance between the first hopper and the second hopper during the injection process of the electrolyte to stably inject the electrolyte into the cell at a constant flow rate, turbulence and air mixing that may occur during the injection process of the electrolyte may be minimized, thereby maintaining uniform filling inside the cell and improving long-term performance stability of the battery.

In some non-limiting embodiments, by combining a method of injecting the electrolyte in a vacuum environment and a method of injecting the electrolyte using nitrogen pressurization to maximize flexibility of a battery manufacturing process, an optimal electrolyte injection method may be selected according to process conditions, efficiency of the battery manufacturing process may be improved, and product quality may be consistently maintained.

### BRIEF DESCRIPTION OF THE DRAWINGS

The above and other objects, features and other advantages of the present disclosure will be more clearly understood from the following detailed description taken in conjunction with the accompanying drawings, in which:

FIG. 1 is a schematic view of components of an apparatus for injecting an electrolyte based on degassing according to an embodiment of the present disclosure.

FIG. 2 is a schematic view illustrating detailed components of a degassing and injection unit in the apparatus for injecting an electrolyte based on degassing according to an embodiment of the present disclosure.

FIG. 3 is a schematic view illustrating detailed components of a degassing and injection unit in the apparatus for injecting an electrolyte based on degassing according to another embodiment of the present disclosure.

FIG. 4 is a schematic view illustrating detailed components of a degassing and injection unit in the apparatus for injecting an electrolyte based on degassing according to another embodiment of the present disclosure.

FIG. 5 is a schematic view illustrating detailed components of a degassing and injection unit in the apparatus for injecting an electrolyte based on degassing according to another embodiment of the present disclosure.

FIG. 6 is a flowchart illustrating a flow of operations for performing degassing of an electrolyte and injecting the degassed electrolyte into a cell in the apparatus for injecting an electrolyte based on degassing according to an embodiment of the present disclosure.

FIG. 7 is a flowchart illustrating a detailed flow of operations for injecting the degassed electrolyte into the cell in the apparatus for injecting an electrolyte based on degassing according to an embodiment of the present disclosure.

FIG. 8 is a flowchart illustrating a flow of operations for pressurizing a second hopper with nitrogen while the electrolyte is injected into the cell in the apparatus for injecting an electrolyte based on degassing according to an embodiment of the present disclosure.

### DETAILED DESCRIPTION

Hereinafter, embodiments or aspects will be described in detail with reference to the accompanying drawings. However, since various changes may be made in the embodiments or aspects, the scope of the patent disclosure is not limited or restricted by these embodiments or aspects. It should be understood that all modifications, equivalents, and alternatives for the embodiments or aspects are comprised in the scope of the present disclosure. For example, it is to be understood that the present disclosure may assume various alternative variations and step sequences, except where expressly specified to the contrary. It is also to be understood that the specific devices and processes illustrated in the attached drawings, and described in the following detailed description, are simply exemplary and non-limiting embodiments or aspects of the disclosed subject matter. Hence, specific dimensions and other physical characteristics related to the embodiments or aspects disclosed herein are not to be considered as limiting.

No aspect, component, element, structure, act, step, function, instruction, and/or the like used herein should be construed as critical or essential unless explicitly described as such. Also, as used herein, the articles “a” and “an” are intended to include one or more items and may be used interchangeably with “one or more” and “at least one.” Furthermore, as used herein, the term “set” is intended to include one or more items (e.g., related items, unrelated items, a combination of related and unrelated items, and/or the like) and may be used interchangeably with “one or more” or “at least one.” Where only one item is intended, the term “one” or similar language is used. Also, as used herein, the terms “comprise”, “comprises”, “comprising”, “include”, “includes”, “including”, “has,” “have,” “having,” or the like are intended to be open-ended terms. Further, the phrase “based on” is intended to mean “based at least partially on” unless explicitly stated otherwise. In addition, reference to an action being “based on” a condition may refer to the action being “in response to” the condition. For example, the phrases “based on” and “in response to” may, in some non-limiting embodiments or aspects, refer to a condition for automatically triggering an action (e.g., a specific operation of an electronic device, such as a computing device, a processor, and/or the like).

It will be understood that when a component is described as being “connected,” “combined” or “coupled” to another component, the component may be directly connected or coupled to the another component, but it may be “connected,” “combined” or “coupled” to the another component by an intervening another component that may be present.

Further, in describing the components of the embodiment or aspect, the meaning of “or” may mean each of the components, may mean two or more of the components, or may mean all of the components. For example, it should be understood that the expressions “a, b or c” represent any one of “a,” “b,” “c,” “a and b,” “a and c,” “b and c,” and “a, b and c.”

Components comprised in one embodiment or aspect and components comprising common functions will be described using the same names in other embodiments or aspects. The description given in one embodiment or aspect may be applied to other embodiments or aspects, and therefore will not be described in detail within the overlapping range, unless there is a description opposite thereto.

The device and/or ‘data’ processed by the device may be expressed in terms of ‘information’. Here, the information may be used as a concept comprising the data.

The present disclosure may describe a method and an apparatus for injecting an electrolyte based on degassing. More specifically, a method and an apparatus for performing degassing (gas removal) from an electrolyte to be injected into a cell (or a battery) and injecting the degassed electrolyte into the cell may be described.

In describing various embodiments below, when the expression processing an electrolyte is used, it may be described as meaning at least one operation of removing gas from the electrolyte and/or injecting the electrolyte into the cell.

In describing various embodiments, the expressions cell and/or battery into which the electrolyte is injected may be used. Here, the cell may refer to a basic electrochemical device including an electrolyte, a positive electrode, and a negative electrode, as a unit structure capable of storing and releasing electrical energy. On the other hand, the battery may be defined as a structure (e.g., a module, a pack, etc.) providing a desired voltage and capacity by connecting one or more cells in series or in parallel.

That is, a target into which the electrolyte is injected may be an individual cell or a battery in which a plurality of cells are combined. In describing various embodiments below, it is described that the electrolyte is injected into the cell, but it will be apparent that the present disclosure is not limited thereto and the electrolyte may be injected into the battery.

The battery (or the cell) according to various embodiments may include a secondary battery.

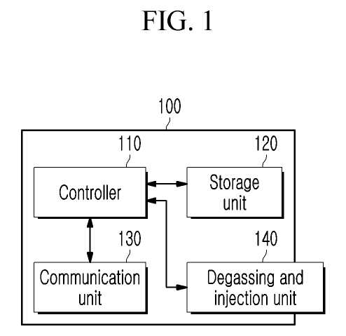

To describe the method and apparatus for injecting an electrolyte, FIG. 1 schematically illustrates components of an apparatus for injecting an electrolyte according to an embodiment of the present disclosure.

Referring to FIG. 1, an apparatus 100 for injecting an electrolyte (hereinafter, the apparatus 100) according to various embodiments of the present disclosure may include at least one of a controller 110, a storage unit 120, a communication unit 130, and a degassing and injection unit 140.

According to an embodiment, the controller 110 may control operations of the degassing and injection unit 140. The storage unit 120 may store data for operations of the controller 110. The communication unit 130 may perform communication with a component inside the apparatus 100 or an external device (e.g., a server, etc.) based on the control of the controller 110. The degassing and injection unit 140 may perform degassing of the electrolyte and perform an operation of injecting the degassed electrolyte into the cell based on the control of the controller 110.

Hereinafter, configurations and operations of the controller 110, the storage unit 120, the communication unit 130, or the degassing and injection unit 140 may be described in detail.

First, the controller 110 includes at least one processor, and may process various data for operations of the apparatus 100 through at least one program (e.g., an application, a tool, a plug-in, software, etc.).

The controller 110 may control operations or functions of components (e.g., the storage unit 120, the communication unit 130, or the degassing and injection unit 140, etc.) included in the apparatus 100 (or connected to the apparatus 100). In this case, the controller 110 may transmit and receive data to and from the components through the communication unit 130.

The storage unit 120 may include a volatile memory, a non-volatile memory, or a computer-readable recording medium like these. In this case, a computer program for the apparatus 100 to perform operations based on various embodiments may be stored in the computer-readable recording medium.

For example, the storage unit 120 may store various data transmitted or processed by at least one component (e.g., the controller 110 or the communication unit 130, etc.) of the apparatus 100. The data may include, for example, a program for processing a control command, data processed through the program, or input data and output data related thereto.

According to an embodiment, at least one program for controlling operations of the degassing and injection unit 140 may be stored in the storage unit 120.

In addition, the storage unit 120 may include an artificial intelligence algorithm based on at least a part of an artificial neural network algorithm, a blockchain algorithm, a deep learning algorithm, a regression analysis algorithm for processing a control command, and mechanisms, operators, language models, and big data related thereto.

The communication unit 130 may establish a wired communication channel or a wireless communication channel between components inside the apparatus 100 and/or between the apparatus 100 and at least one other device (e.g., a user device, or a server), and may support performing communication through the established communication channel.

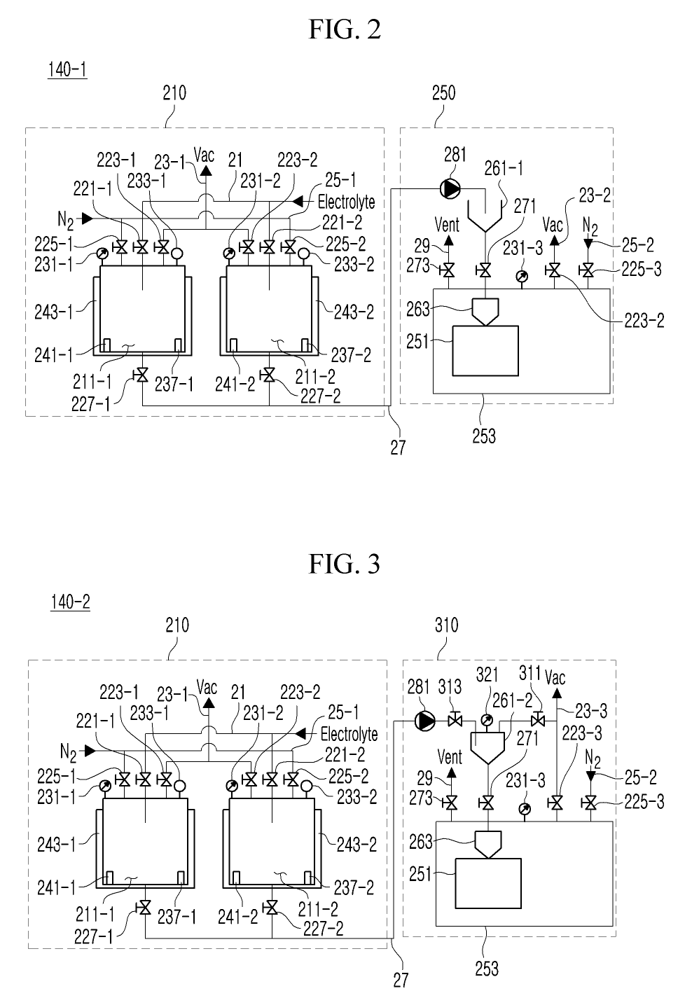

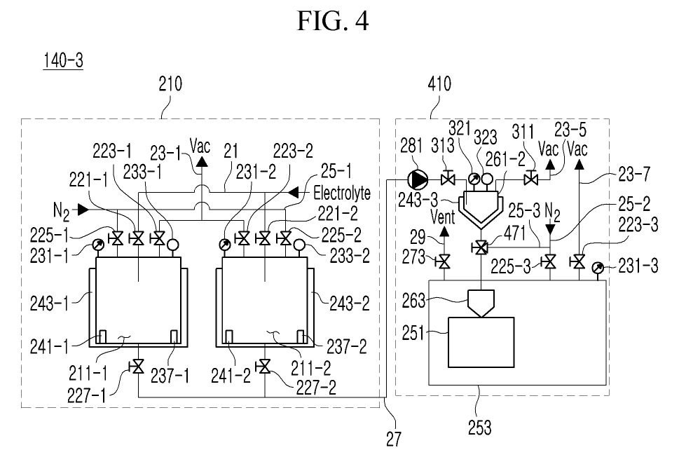

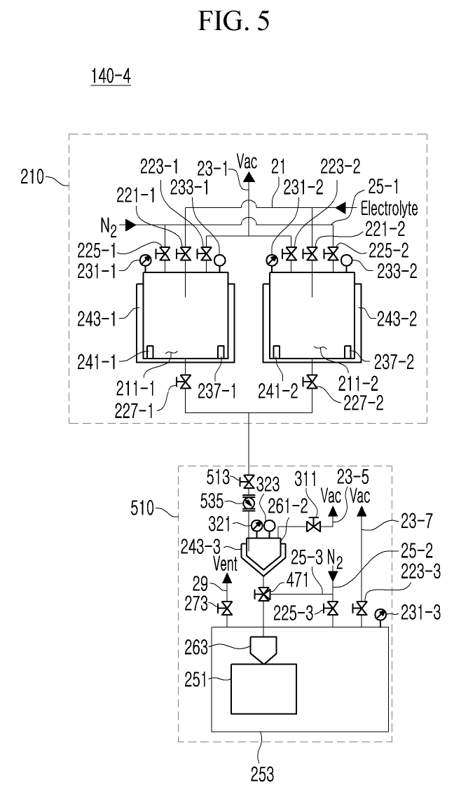

Hereinafter, the configuration of the degassing and injection unit 140 may be described in more detail with reference to FIGS. 2, 3, 4, and 5. To this end, FIG. 2 illustrates detailed components of the degassing and injection unit in the apparatus for injecting an electrolyte according to an embodiment of the present disclosure. FIG. 3 illustrates detailed components of the degassing and injection unit in the apparatus for injecting an electrolyte according to another embodiment of the present disclosure. FIG. 4 illustrates detailed components of the degassing and injection unit in the apparatus for injecting an electrolyte according to another embodiment of the present disclosure. In addition, FIG. 5 illustrates detailed components of the degassing and injection unit in the apparatus for injecting an electrolyte according to another embodiment of the present disclosure.

Referring to FIGS. 2, 3, 4, and 5, the degassing and injection unit 140 may include a degassing unit 210 and injection units 250, 310, 410, and 510.

Hereinafter, the configuration of the degassing and injection unit 140 may be described with reference to FIGS. 2, 3, 4, and 5 .

The degassing unit 210 may include a tank 211 in which an electrolyte for degassing is stored. Here, an electrolyte supply line 21 for supplying the electrolyte, a vacuum line 23-1 for controlling a pressure inside the tank 211, a nitrogen supply line 25-1 for supplying nitrogen (N2) gas to the tank 211, and an electrolyte transfer line 27 for transferring the electrolyte discharged from the tank 211 to the injection units 250 and 310 may be connected to the tank 211.

Here, at least one line (e.g., the electrolyte supply line 21, the vacuum line 23-1, the nitrogen supply line 25-1, the electrolyte transfer line 27, or a hopper line, a vent line 29, etc., which will be described later) may be configured as a hard pipe such as iron, stainless steel, aluminum, carbon steel, copper, or PVC, or a soft pipe such as rubber, Teflon, nylon, silicone, synthetic resin, or metal braid. In addition, the at least one line may include a pipe formed by mixing a hard pipe and a soft pipe (or mixing materials thereof).

In addition, an electrolyte inlet valve 221 for controlling a flow of the electrolyte introduced into the tank 211 may be connected to the electrolyte supply line 21. In addition, a tank vacuum control valve 223 for controlling an air flow with the tank 211 may be connected to the vacuum line 23-1. In addition, a nitrogen inlet valve 225 for controlling a flow of the nitrogen gas introduced into the tank 211 may be connected to the nitrogen supply line 25-1. In addition, an electrolyte outlet valve 227 for controlling a flow of the electrolyte (degassed electrolyte) discharged from the tank 211 may be connected to the electrolyte transfer line 27.

In addition, a pressure gauge 231 for measuring the internal pressure of the tank 211 and a thermometer 233 for measuring a temperature of the electrolyte stored inside the tank 211 may be configured in the tank 211.

In addition, an internal heating unit 241 for heating the electrolyte stored inside the tank 211 using an electrolyte heating method and/or an external heating unit 243 for heating the electrolyte stored inside the tank 211 using a storage container heating method may be configured in the tank 211.

More specifically, the internal heating unit 241 may include an immersion heater, an induction heater, or the like, and may be configured to be in contact with the electrolyte inside the tank 211-1.

In addition, the external heating unit 243 may include a heating jacket, a heating band, an external heat exchanger, or the like, and may be configured to surround or contact the tank 211-1 from the outside of the tank 211-1.

In describing various embodiments of the present disclosure, the pressure may be described based on a gauge pressure (kPa). However, the present disclosure is not limited thereto, and various embodiments may be described by converting into an absolute pressure (kPa abs) calculated as the sum of the gauge pressure (kPa) and an atmospheric pressure (e.g., 101.325 kPa abs). In describing the embodiments of the present disclosure, unless a unit for pressure is specifically specified, it may represent a gauge pressure.

According to various embodiments, the degassing unit 210 may include two tanks 211-1 and 211-2 in which the electrolyte for degassing is stored. Here, each of the two tanks 211-1 and 211-2 may alternately perform degassing of the electrolyte to inject the degassed electrolyte into the cell. Based on this, the operations of degassing and injecting the electrolyte of the first tank 211-1 and the second tank 211-2 may be operated alternately.

Hereinafter, the two tanks 211-1 and 211-2 configured in the degassing unit 210 may be described in more detail with reference to FIGS. 2 and 3.

An electrolyte supply line 21 for supplying the electrolyte to the tanks 211-1 and 211-2, a vacuum line 23-1 for controlling internal pressures of the tanks 211-1 and 211-2, a nitrogen supply line 25-1 for supplying nitrogen (N2) gas to the tanks 211-1 and 211-2, and an electrolyte transfer line 27 for transferring the electrolyte discharged from the tanks 211-1 and 211-2 to the injection units 250 and 310 may be connected to each of the tanks 211-1 and 211-2.

In addition, an electrolyte inlet valve 221-1 for controlling a flow of the electrolyte introduced into the tank 211-1 and an electrolyte inlet valve 221-2 for controlling a flow of the electrolyte introduced into the tank 211-2 may be connected to the electrolyte supply line 21. In addition, a tank vacuum control valve 223-1 for controlling an air flow with the tank 211-1 and a tank vacuum control valve 223-2 for controlling an air flow with the tank 211-2 may be connected to the vacuum line 23-1. In addition, a nitrogen inlet valve 225-1 for controlling a flow of the nitrogen gas introduced into the tank 211-1 and a nitrogen inlet valve 225-2 for controlling a flow of the nitrogen gas introduced into the tank 211-2 may be connected to the nitrogen supply line 25-1. In addition, an electrolyte outlet valve 227-1 for controlling a flow of the electrolyte (degassed electrolyte) discharged from the tank 211-1 and an electrolyte outlet valve 227-2 for controlling a flow of the electrolyte (degassed electrolyte) discharged from the tank 211-2 may be connected to the electrolyte transfer line 27.

In addition, a pressure gauge 231-1 for measuring the internal pressure of the tank 211-1 and a thermometer 233-1 for measuring a temperature of the electrolyte stored inside the tank 211-1 may be configured in the tank 211-1. In addition, a pressure gauge 231-2 for measuring the internal pressure of the tank 211-2 and a thermometer 233-2 for measuring a temperature of the electrolyte stored inside the tank 211-2 may be configured in the tank 211-2.

In addition, an internal heating unit 241-1 for heating the electrolyte stored inside the tank 211 using an electrolyte heating method and/or an external heating unit 243-1 for heating the electrolyte stored inside the tank 211-1 using a storage container heating method may be configured in the tank 211-1. In addition, an internal heating unit 241-2 for heating the electrolyte stored inside the tank 211-2 using an electrolyte heating method and/or an external heating unit 243-2 for heating the electrolyte stored inside the tank 211-2 using a storage container heating method may be configured in the tank 211-2.

Hereinafter, the configuration of the injection unit 250 configured in the first degassing and injection unit 140-1 may be described with reference to FIG. 2.

The injection unit 250 may include a first hopper (1-1 hopper 261-1) in which the electrolyte (degassed electrolyte) transferred from the electrolyte transfer line 27 is stored, a second hopper 263 in which the electrolyte transferred from the first hopper 261-1 is stored, a hopper line connecting the first hopper 261-1 and the second hopper 263, a cell 251 into which the electrolyte is injected from the second hopper 263, and a chamber 253 configured to control an internal pressure of the cell 251 in a state in which the cell 251 is located therein for injection of the electrolyte.

Here, the first hopper 261-1 may be configured outside the chamber 253, and the second hopper 263 may be configured inside the chamber 253.

In addition, the second hopper 263 may be configured to be connectable to or separable from the cell 251 inside the chamber 253. The second hopper 263 may inject the electrolyte inside the second hopper 263 into the cell 251 in a state of being connected to the cell 251.

At this time, internal pressures of the second hopper 263 and/or the cell 251 may be equally controlled according to the internal pressure control of the chamber in a state in which the second hopper 263 or the cell 251 is located inside the chamber 253.

In addition, a control valve 271 for controlling a flow of the electrolyte from the first hopper 261-1 to the second hopper 263 may be connected to the hopper line between the first hopper 261-1 and the second hopper 263.

In addition, a vacuum line 23-2 for controlling an internal pressure of the chamber 253, a nitrogen supply line 25-2 for supplying nitrogen (N2) gas to the chamber 253, and a vent line 29 for forming an atmospheric pressure inside the chamber 253 by controlling an air flow inside the chamber 253 may be connected to the chamber 253.

In addition, a chamber vacuum control valve 223-3 for controlling an air flow with the chamber 253 may be connected to the vacuum line 23-2. In addition, a nitrogen inlet valve 225-3 for controlling a flow of the nitrogen gas introduced into the chamber 253 may be connected to the nitrogen supply line 25-2. In addition, a vent valve 273 for controlling an air flow with the chamber 253 may be connected to the vent line 29.

In addition, a pump 281 for transferring the electrolyte discharged from the tank 211 to the first hopper 261-1 may be connected to the transfer line 27 between the electrolyte outlet valve 227 and the first hopper 261-1. Here, the pump 281 may be configured as a metering pump (or a gear pump, a diaphragm pump, etc.) for controlling a flow rate provided to the first hopper 261-1.

In addition, a pressure gauge 231-3 for measuring the internal pressure of the chamber 253 may be configured in the chamber 253.

Hereinafter, the configuration of the injection unit 310 configured in the second degassing and injection unit 140-2 may be described with reference to FIG. 3.

The injection unit 310 may include a first hopper (1-2 hopper 261-2) in which the electrolyte (degassed electrolyte) transferred from the electrolyte transfer line 27 is stored, a second hopper 263 in which the electrolyte transferred from the first hopper 261-2 is stored, a hopper line connecting the first hopper 261-2 and the second hopper 263, a cell 251 into which the electrolyte is injected from the second hopper 263, and a chamber 253 configured to control an internal pressure of the cell 251 in a state in which the cell 251 is located therein for injection of the electrolyte.

Here, the first hopper 261-2 may be configured outside the chamber 253, and the second hopper 263 may be configured inside the chamber 253.

The first hopper 261-2 may be configured in a sealed structure to form an internal pressure. Here, a pressure gauge 321 for measuring the internal pressure of the first hopper 261-2 may be configured in the first hopper 261-2.

In addition, the second hopper 263 may be configured to be connectable to or separable from the cell 251 inside the chamber 253. The second hopper 263 may inject the electrolyte inside the second hopper 263 into the cell 251 in a state of being connected to the cell 251.

At this time, internal pressures of the second hopper 263 and/or the cell 251 may be equally controlled according to the internal pressure control of the chamber in a state in which the second hopper 263 or the cell 251 is located inside the chamber 253.

In addition, a control valve 271 for controlling a flow of the electrolyte from the first hopper 261-2 to the second hopper 263 may be connected to the hopper line between the first hopper 261-2 and the second hopper 263.

In addition, a nitrogen supply line 25-2 for supplying nitrogen (N2) gas to the chamber 253, and a vent line 29 for forming an atmospheric pressure inside the chamber 253 by controlling an air flow inside the chamber 253 may be connected to the chamber 253. In addition, a vacuum line 23-3 for controlling internal pressures of the first hopper 261-2 and the chamber 253 may be formed in the injection unit 310.

At this time, a chamber vacuum control valve 223-3 for controlling an air flow with the chamber 253 and a hopper vacuum control valve 311 for controlling an air flow with the first hopper 261-2 may be connected to the vacuum line 23-3. In addition, a nitrogen inlet valve 225-3 for controlling a flow of the nitrogen gas introduced into the chamber 253 may be connected to the nitrogen supply line 25-2. In addition, a vent valve 273 for controlling an air flow with the chamber 253 may be connected to the vent line 29.

In addition, a pump 281 for transferring the electrolyte discharged from the tank 211 to the first hopper 261-2 may be connected to the transfer line 27 between the electrolyte outlet valve 227 and the first hopper 261-2. Here, the pump 281 may be configured as a metering pump (or a gear pump, a diaphragm pump, etc.) for controlling a flow rate provided to the first hopper 261-2.

In addition, a backflow prevention valve 313 for maintaining the pressure formed inside the first hopper 261-2 may be connected between the pump 281 and the first hopper 261-2.

Hereinafter, the configuration of the injection unit 410 configured in the third degassing and injection unit 140-3 may be described with reference to FIG. 4.

The injection unit 410 may include a first hopper 261-2 in which the electrolyte (degassed electrolyte) transferred from the electrolyte transfer line 27 is stored, a second hopper 263 in which the electrolyte transferred from the first hopper 261-2 is stored, a hopper line connecting the first hopper 261-2 and the second hopper 263, a cell 251 into which the electrolyte is injected from the second hopper 263, and a chamber 253 configured to control an internal pressure of the cell 251 in a state in which the cell 251 is located therein for injection of the electrolyte.

Here, the first hopper 261-2 may be configured outside the chamber 253, and the second hopper 263 may be configured inside the chamber 253.

The first hopper 261-2 may be configured in a sealed structure to form an internal pressure. Here, a pressure gauge 321 for measuring the internal pressure of the first hopper 261-2, and a thermometer 323 for measuring a temperature of the electrolyte stored inside the first hopper 261-2 may be configured in the first hopper 261-2.

In addition, the second hopper 263 may be configured to be connectable to or separable from the cell 251 inside the chamber 253. The second hopper 263 may inject the electrolyte inside the second hopper 263 into the cell 251 in a state of being connected to the cell 251.

At this time, internal pressures of the second hopper 263 and/or the cell 251 may be equally controlled according to the internal pressure control of the chamber in a state in which the second hopper 263 or the cell 251 is located inside the chamber 253.

In addition, a control valve 471 for controlling a flow of the electrolyte from the first hopper 261-2 to the second hopper 263 may be connected to the hopper line between the first hopper 261-2 and the second hopper 263.

In addition, a nitrogen supply line 25-2 for supplying nitrogen (N₂) gas to the chamber 253, and a vent line 29 for forming an atmospheric pressure inside the chamber 253 by controlling an air flow inside the chamber 253 may be connected to the chamber 253.

In addition, a nitrogen supply line 25-3 for supplying nitrogen (N₂) gas to the second hopper 263 may be connected to the second hopper 263. Here, the nitrogen supply line 25-3 may be connected to the control valve 471 to provide the nitrogen (N₂) gas to the second hopper 263 according to the control of the control valve 471. To this end, the control valve 471 may be configured as a 3-way valve.

In addition, a vacuum line 23-5 for controlling the internal pressure of the first hopper 261-2, and a vacuum line 23-7 for controlling the internal pressure of the chamber 253 may be formed in the injection unit 410.

At this time, a hopper vacuum control valve 311 for controlling an air flow with the first hopper 261-2 may be connected to the vacuum line 23-5. In addition, a chamber vacuum control valve 223-3 for controlling an air flow with the chamber 253 may be connected to the vacuum line 23-7.

In addition, a nitrogen inlet valve 225-3 for controlling a flow of the nitrogen gas introduced into the chamber 253 may be connected to the nitrogen supply line 25-2. In addition, a vent valve 273 for controlling an air flow with the chamber 253 may be connected to the vent line 29.

In addition, a pump 281 for transferring the electrolyte discharged from the tank 211 to the first hopper 261-2 may be connected to the transfer line 27 between the electrolyte outlet valve 227 and the first hopper 261-2. Here, the pump 281 may be configured as a metering pump (or a gear pump, a diaphragm pump, etc.) for controlling a flow rate provided to the first hopper 261-2.

In addition, a backflow prevention valve 313 for maintaining the pressure formed inside the first hopper 261-2 may be connected between the pump 281 and the first hopper 261-2.

In addition, an external heating unit 243-3 for heating the electrolyte stored inside the first hopper 261-2 using a storage container heating method (or a hopper heating method) may be configured in the first hopper 261-2. Here, the external heating unit 243-3 may be configured to heat the storage container from the outside of the storage container (the first hopper 261-2) in the same or similar manner as the external heating unit 243-1 or 243-2 of the storage container heating method.

In addition, although not illustrated through FIG. 4, the first hopper 261-2 may be configured to further include an internal heating unit (not shown) for heating the electrolyte stored inside the first hopper 261-2 using an electrolyte heating method. Here, the internal heating unit (not shown) may be configured in the same or similar manner as the internal heating unit 241-1 or 241-2 of the electrolyte heating method.

According to various embodiments, when an external heating unit 243-3 and/or an internal heating unit (not shown) are configured in the first hopper 261-2, the tank 211-1 or 211-2 may be configured not to include the internal heating unit 241-1 or 241-2 or the external heating unit 243-1 or 243-2.

Hereinafter, the configuration of the injection unit 510 configured in the fourth degassing and injection unit 140-4 may be described with reference to FIG. 5.

First, referring to FIG. 5, the injection unit 510 may be configured similarly to the injection unit 410 illustrated and described with reference to FIG. 4. Similarly, the degassing unit 210 may also be configured not to include the internal heating unit 241 or the external heating unit 243 as described with reference to FIG. 4.

The injection unit 510 may be configured not to include the pump 281 for transferring the electrolyte discharged from the tank 211 to the first hopper 261-2 between the electrolyte outlet valve 227 of the electrolyte transfer line 27 and the first hopper 261-2.

To this end, the degassing unit 210 (or the tank 211 of the degassing unit 210) may be disposed at a higher position than the injection unit 510 (or the first hopper 261-2 of the injection unit 510).

By disposing the degassing unit 210 at a position higher than the injection unit 510, the electrolyte may be transferred from the tank 211 to the first hopper 261-2 based on gravity. However, the present disclosure is not limited thereto, and as described above, a pressure difference between the degassing unit 210 and the injection unit 510 and/or pressurizing with nitrogen may be applied so that the electrolyte may be transferred from the tank 211 to the first hopper 261-2.

The fourth degassing and injection unit 140-4 may prevent an increase in a dissolved gas concentration of the electrolyte that may occur due to an operation of the pump 281 by transferring the electrolyte from the tank 211 to the first hopper 261-2 without power of the pump 281.

At this time, an electrolyte transfer valve 513 for controlling an amount and/or a flow of the electrolyte (degassed electrolyte) introduced into the first hopper 261-2 may be connected between the electrolyte outlet valve 227 of the electrolyte transfer line 27 and the first hopper 261-2.

In addition, a flow meter 535 for measuring an amount of the electrolyte flowing into the first hopper 261-2 past the electrolyte transfer valve 513 may be connected below the electrolyte transfer valve 513 of the electrolyte transfer line 27. However, the flow meter 535 may be connected above the electrolyte transfer valve 513 in the electrolyte transfer line 27.

In describing FIG. 5, it has been described that the degassing unit 210 (or the tank 211 of the degassing unit 210) is disposed at a higher position than the injection unit 510 (or the first hopper 261-2 of the injection unit 510). Similarly, the degassing unit 210 configured through FIG. 2, 3, or 4 may also be disposed at a higher position than the injection units 250, 310, or 410.

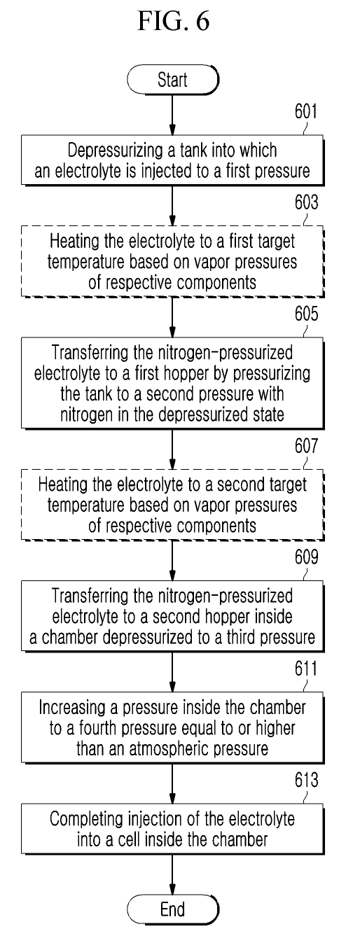

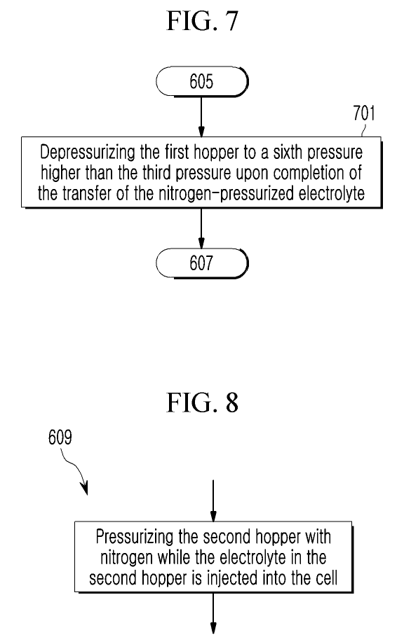

Hereinafter, a flow of operations for performing degassing of an electrolyte through the degassing and injection unit 140 in the apparatus 100 for injecting an electrolyte and injecting the degassed electrolyte into the cell 251 may be described in detail with reference to FIGS. 6 and 7. FIG. 6 is a flowchart illustrating a flow of operations for performing degassing of an electrolyte and injecting the degassed electrolyte into a cell in the apparatus for injecting an electrolyte according to an embodiment of the present disclosure. FIG. 7 is a flowchart illustrating a detailed flow of operations for injecting the degassed electrolyte into the cell in the apparatus for injecting an electrolyte according to an embodiment of the present disclosure. FIG. 8 is a flowchart illustrating a flow of operations for pressurizing a second hopper with nitrogen while the electrolyte is injected into the cell in the apparatus for injecting an electrolyte according to an embodiment of the present disclosure.

Hereinafter, in describing the embodiments of FIG. 6, operations of the degassing unit 210 may be described based on operations performed on the first tank 211-1. At this time, operations performed in the first tank 211-1 may be identically or similarly performed in the second tank 211-2. However, as described above, in order to alternately inject the electrolyte degassed in the first tank 211-1 and the electrolyte degassed in the second tank 211-2 into the cell 251, a timing at which operations for degassing the electrolyte are performed and/or a timing at which the degassed electrolyte is discharged in each of the first tank 211-1 and the second tank 211-2 may be set differently.

In operation 601, the controller 110 may depressurize the tank 211-1 into which the electrolyte is injected to a first pressure.

Describing in more detail with reference to FIGS. 2 and 3, first, the controller 110 may open the electrolyte inlet valve 221-1 to introduce a preset amount of the electrolyte into the tank 211-1. For example, the controller 110 may introduce a preset amount of the electrolyte into the tank 211-1 based on an amount designated to be injected into the cell 251, or may introduce an amount of a preset ratio (e.g., 80%) into the tank 211-1 based on a volume (capacity) of the tank 211-2.

When the electrolyte is introduced into the tank 211-1, the controller 110 may depressurize the internal pressure of the tank 211-1 to a preset first pressure (a tank reference pressure). Here, the first pressure is an operating pressure of the tank 211-1, and a degassing operation of the electrolyte may be performed at the first pressure. According to an embodiment, the first pressure may be set to -70 kPa. However, the first pressure may be set differently based on performance and volume of the tank 211-1, and/or components of the electrolyte. For example, the first pressure may be set to a specific value between -91 kPa and 0 kPa.

In operation 603, the controller 110 may heat the electrolyte stored in the tank 211-1 to a first target temperature based on vapor pressures of respective components.

For example, the first target temperature may be a state set to a value such that a corresponding vapor pressure of a component having a highest vapor pressure among the components included in the electrolyte is less than the first pressure in a state where the internal pressure of the tank 211-1 is maintained at the first pressure.

The controller 110 may heat the electrolyte stored in the tank 211-1 using a storage container heating method or an electrolyte heating method.

According to an embodiment, when the tank 211-1 is configured to include an internal heating unit 241-1, the controller 110 may directly heat the electrolyte stored in the tank 211-1 by controlling the internal heating unit 241-1.

On the other hand, when the tank 211-1 is configured to include an external heating unit 243-1, the controller 110 may heat the tank 211-1 by controlling the external heating unit 243-1, and accordingly, the inside of the tank 211-1 is heated so that the electrolyte stored inside the tank 211-1 may be indirectly heated.

More specifically, a temperature sensor (not shown) that contacts an inner wall and measures a temperature of the inner wall of the tank 211-1 may be configured inside the tank 211-1. At this time, the controller 110 may heat the electrolyte by controlling a temperature of the external heating unit 243-1 such that the temperature measured from the temperature sensor (not shown) satisfies the first target temperature (reaches the first target temperature).

As described above, the tank 211 is configured to include the external heating unit 243 and/or the internal heating unit 241, and the controller 110 may heat the electrolyte inside the tank 211 to reach the first target temperature by controlling the external heating unit 243 and/or the internal heating unit 241.

In addition, according to various embodiments, the tank 211 may include a dissolved gas sensor 237 for detecting a dissolved gas concentration inside the tank 211.

According to an embodiment, the controller 110 may measure a dissolved gas concentration of the electrolyte stored inside the tank 211-1 through the dissolved gas sensor 237-1 (or the dissolved gas sensor 237-2 in the case of the tank 211-2), and control the first target temperature such that the dissolved gas concentration is less than a preset value (e.g., is not detected).

For example, in a state where the temperature of the electrolyte stored in the tank 211-1 maintains the first target temperature, the controller 110 may measure the dissolved gas concentration of the electrolyte stored in the tank 211-1 at preset time intervals or in real time.

When the dissolved gas concentration of the electrolyte is equal to or greater than the preset value, the controller 110 may decrease the first target temperature in units of a preset value (e.g., 0.5 °C, or 1 °C, etc.).

In addition, the controller 110 may control a heating time of the tank 211-1 and/or the electrolyte by controlling operations of the internal heating unit 241-1 and/or the external heating unit 243-1 such that the dissolved gas concentration is less than the preset value (e.g., is not detected).

Through this, by heating the electrolyte within a range that does not cause evaporation of electrolyte components inside the tank 211-1, it is possible to effectively remove dissolved gas while improving degassing efficiency, and minimize the dissolved gas concentration in the electrolyte.

According to the above description, the dissolved gas concentration of the preset value (a dissolved gas concentration reference value) for controlling the first target temperature has been described as one in which the dissolved gas is not detected. However, the present disclosure is not limited thereto, and the dissolved gas concentration reference value may be changed according to settings.

According to various embodiments, as described with reference to FIGS. 4 and 5, when the tank 211-1 or 211-2 of the degassing unit 210 does not include the internal heating unit 241 or the external heating unit 243, operation 603 may not be performed. However, even if the tanks 211-1 and 211-2 of the degassing unit 210 include the internal heating unit 241 or the external heating unit 243, operation 603 may not be performed depending on settings.

When operation 603 is not performed, the operation of heating the electrolyte may be performed through operation 607.

In operation 605, the controller 110 may transfer the nitrogen-pressurized electrolyte to the first hopper 261 by pressurizing the tank 211-1 to a second pressure with nitrogen in a depressurized state (e.g., a first pressure state).

First, when the degassing and injection unit 140 is configured to include the injection unit 250, the controller 110 may pressurize the inside of the tank 211-1 with nitrogen through the nitrogen supply line 25-1 by opening the nitrogen inlet valve 225-1 in a state where the first pressure of the tank 211-1 is maintained (e.g., a closed state of the tank vacuum control valve 223-1).

According to an embodiment, the controller 110 may pressurize the inside of the tank 211-1 to the second pressure that is a preset value equal to or greater than 100 kPa, and discharge the degassed electrolyte to the electrolyte transfer line 27 by opening the electrolyte outlet valve 227-1 (or the electrolyte outlet valve 227-2 in the case of the tank 211-2).

At this time, the controller 110 may control opening/closing of the electrolyte outlet valve 227-1 such that a preset amount (a cell injection amount) is discharged. In addition, the controller 110 may control a flow rate change of the nitrogen supplied to the tank 211-1 through a flow controller (e.g., a mass flow controller (MFC)) (not shown) configured in the nitrogen supply line 25-1 to prevent scattering of the electrolyte discharged through the electrolyte outlet valve 227-1.

According to an embodiment, the controller 110 may control an opening speed of the nitrogen inlet valve 225-1 to control a rapid pressure change due to the inflow of nitrogen in a state where the internal pressure of the tank 211-1 is maintained at the first pressure.

The controller 110 may gradually increase the pressure inside the tank 211-1 by gradually increasing the opening speed of the nitrogen inlet valve 225-1. In addition, the controller 110 may open/close the nitrogen inlet valve 225 and/or the electrolyte outlet valve 227 in a pulse form to prevent (or minimize) occurrence of turbulence in the transferred electrolyte.

Here, as illustrated in FIGS. 2 and 3, when the pump 281 is connected to the electrolyte transfer line 27, the controller 110 may operate the pump 281 connected to the electrolyte transfer line 27 to transfer the electrolyte introduced into the electrolyte transfer line 27 to the first hopper 261-1 or 261-2.

According to an embodiment, when the pump 281 configured in the injection unit 250 is a metering pump, the controller 110 may supply nitrogen to the tank 211-1 at an atmospheric pressure (0 kPa) level to control the internal pressure of the tank 211-1, and operate the metering pump to transfer the electrolyte of a preset cell injection amount to the first hopper 261-1.

Here, when the degassing and injection unit 140 is configured to include the injection unit 310, the controller 110 may transfer the electrolyte in the tank 211-1 to the hopper 261-2 in the same or similar manner as when the degassing and injection unit 140 is configured to include the injection unit 250.

On the other hand, as illustrated in FIG. 5, when the pump 281 is not configured in the electrolyte transfer line 27, the electrolyte stored in the tank 211-1 may be transferred to the first hopper 261-2 based on gravity caused by a height difference between the degassing unit 210 and the injection unit 510.

However, the present disclosure is not limited thereto, and a pressure difference between the degassing unit 210 and the injection unit 510 and/or nitrogen pressurization may be applied so that the electrolyte may be transferred from the tank 211 to the first hopper 261-2.

Accordingly, the controller 110 may calculate an amount of the electrolyte flowing into the first hopper 261-2 past the electrolyte transfer valve 513 through the flow meter 535 configured in the electrolyte transfer line 27, and based on this, may open/close the electrolyte transfer valve 513 to transfer the electrolyte of the preset cell injection amount to the first hopper 261-2.

When the electrolyte corresponding to a cell injection amount flows into the first hopper 261-2, the controller 110 may close the backflow prevention valve 313, and depressurize an internal pressure of the first hopper 261-2 to a preset pressure (a hopper reference pressure) higher than an internal pressure (a third pressure) of the chamber 253 (operation 701).

According to an embodiment, the internal pressure of the chamber 253 may be in a state depressurized to the third pressure (e.g., -95 kPa) between -91 kPa and -101.2 kPa in a state where the cell 251 is connected to the second hopper 263 inside the chamber 253. However, although it is described that the third pressure is -95 kPa, it may be changed according to settings.

Here, the hopper reference pressure may be set to a specific value having a value within a preset pressure difference. More specifically, the hopper reference pressure may be set to a value (e.g., -80 kPa) less than a first pressure (e.g., -70 kPa) and exceeding the third pressure (e.g., -95 kPa). Here, although it is described that the hopper reference pressure is -80 kPa, it may be changed according to settings. In addition, the hopper reference pressure may be set in a direction to reduce a difference from the third pressure.

Based on this, the controller 110 may open the hopper vacuum control valve 311 of the vacuum line 23-3 to depressurize the internal pressure of the first hopper 261-2 to the hopper reference pressure.

In operation 607, the controller 110 may heat the electrolyte stored in the first hopper 261-2 to a second target temperature based on vapor pressures of respective components.

For example, the second target temperature may be a state set to a value such that a corresponding vapor pressure of a component having a highest vapor pressure among the components included in the electrolyte is less than the hopper reference pressure in a state where the internal pressure of the first hopper 261-2 is maintained at the hopper reference pressure.

The controller 110 may heat the electrolyte stored in the first hopper 261-2 using a storage container heating method or an electrolyte heating method.

According to an embodiment, when the first hopper 261-2 is configured to include the external heating unit 243-3, the controller 110 may heat the first hopper 261-2 by controlling the external heating unit 243-3, and accordingly, the inside of the first hopper 261-2 is heated so that the electrolyte stored inside the first hopper 261-2 may be indirectly heated.

On the other hand, when the first hopper 261-2 is configured to include the internal heating unit (not shown), the controller 110 may directly heat the electrolyte stored in the first hopper 261-2 by controlling the internal heating unit (not shown).

As described above, the first hopper 261-2 is configured to include the external heating unit 243-3 and/or the internal heating unit (not shown), and the controller 110 may heat the electrolyte inside the first hopper 261-2 to reach the second target temperature by controlling the external heating unit 243-3 and/or the internal heating unit (not shown).

In addition, according to various embodiments, the first hopper 261-2 may include a dissolved gas sensor (not shown) for detecting a dissolved gas concentration inside the first hopper 261-2.

According to an embodiment, the controller 110 may measure a dissolved gas concentration of the electrolyte stored inside the first hopper 261-2 through the dissolved gas sensor (not shown), and control the second target temperature such that the dissolved gas concentration is less than a preset value (e.g., is not detected).

For example, in a state where the temperature of the electrolyte stored in the first hopper 261-2 maintains the second target temperature, the controller 110 may measure the dissolved gas concentration of the electrolyte stored in the first hopper 261-2 at preset time intervals or in real time.

When the dissolved gas concentration of the electrolyte is equal to or greater than the preset value, the controller 110 may decrease the second target temperature in units of a preset value (e.g., 0.5 °C, or 1 °C, etc.).

In addition, the controller 110 may control a heating time of the first hopper 261-2 and/or the electrolyte by controlling operations of the internal heating unit (not shown) and/or the external heating unit 243-3 of the first hopper 261-2 such that the dissolved gas concentration is less than the preset value (e.g., is not detected).

Through this, by heating the electrolyte within a range that does not cause evaporation of electrolyte components inside the first hopper 261-2, it is possible to effectively remove dissolved gas while improving degassing efficiency, and minimize the dissolved gas concentration in the electrolyte.

According to the above description, the dissolved gas concentration of the preset value (a dissolved gas concentration reference value) for controlling the second target temperature has been described as one in which the dissolved gas is not detected. However, the present disclosure is not limited thereto, and the dissolved gas concentration reference value may be changed according to settings.

According to various embodiments, as described with reference to FIGS. 2 and 3, when the internal heating unit (not shown) or the external heating unit 243-3 is not included in the first hopper 261-1 or 261-2 of the injection units 250 and 310, operation 607 may not be performed. However, even if the first hopper 261-1 or 261-2 of the injection units 250 and 310 includes the internal heating unit (not shown) or the external heating unit 243-3, operation 607 may not be performed depending on settings.

When operation 607 is not performed, the operation of heating the electrolyte may be performed through operation 603.

In operation 609, the controller 110 may transfer the nitrogen-pressurized electrolyte at the hopper reference pressure to the second hopper 263 located inside the chamber 253 in a state depressurized to the third pressure.

More specifically, the second hopper 263 is located inside the chamber 253 as described above, and an internal pressure of the second hopper 263 may also be controlled according to the internal pressure control of the chamber 253.

For example, the controller 110 may control the internal pressure of the second hopper 263 to the third pressure by controlling the internal pressure of the chamber 253 to the third pressure.

The controller 110 may open the control valve 271 to transfer the electrolyte inside the first hopper 261-2 to the second hopper 263. At this time, since the internal pressure of the second hopper 263 is lower than the internal pressure of the first hopper 261-2, and a pressure difference between the first hopper 261-2 and the second hopper 263 is small, the electrolyte may be stably transferred without scattering or bubble formation.

Here, the controller 110 may control an opening time of the control valve 271 by calculating a flow rate of the electrolyte flowing according to the opening/closing of the control valve 271 so that impurities (e.g., nitrogen gas) other than the electrolyte stored in the first hopper 261-2 do not flow into the second hopper 263. When all the electrolyte stored in the first hopper 261-2 is transferred to the second hopper 263, the controller 110 may close the control valve 271 to minimize the inflow of impurities.

The injection of the electrolyte into the cell 251 may be started as the electrolyte flows into the second hopper 263 in operation 609 or through operation 611.

In operation 611, the controller 110 may increase the pressure inside the chamber to a fourth pressure equal to or higher than an atmospheric pressure.

More specifically, when the transfer of the electrolyte of the cell injection amount to the second hopper 263 is completed, the controller 110 may open the vent valve 273 of the vent line 29 to increase the internal pressure of the chamber 253 to the atmospheric pressure.

In operation 613, the controller 110 may complete the injection of the electrolyte from the second hopper 263 into the cell 251 located inside the chamber 253.

Here, the controller 110 may open the nitrogen inlet valve 225-3 of the nitrogen supply line 25-2 to pressurize the chamber 253 with nitrogen so that the internal pressure of the chamber 253 exceeds the fourth pressure (or the atmospheric pressure).

According to an embodiment, when detecting that a moving speed of the electrolyte injected from the second hopper 263 to the cell 251 decreases, the controller 110 may pressurize the chamber 253 with nitrogen to increase the internal pressure of the chamber 253 to a preset fifth pressure exceeding the fourth pressure. To this end, a flow meter (not shown) for calculating a flow rate of the electrolyte injected into the cell 251 may be connected between the second hopper 263 and the cell 251.

When the injection of the electrolyte into the cell 251 is completed, the controller 110 may open the vent valve 273 of the vent line 29 to control the internal pressure of the chamber 253 to the atmospheric pressure.

In addition, when the degassing unit 210 includes two tanks 211-1 and 211-2 as described above, the controller 110 may control the electrolyte degassed in each tank to alternately flow into the cell 251.

For example, the controller 110 may control operations 601 to 605 to be performed alternately or with a time difference for each of the two tanks 211-1 and 211-2. In addition, the controller 110 may control operations 607 to 613 to be performed alternately on the electrolyte degassed in the two tanks 211-1 and 211-2.

In this case, so that the electrolyte degassed in each tank can be constantly supplied, the controller 110 may operate in a manner of starting a degassing process in the next tank immediately when an electrolyte degassing process in one tank is completed or while the electrolyte degassing process is being performed in one tank. Through this, it is possible to maximize process efficiency by enabling continuous supply of the electrolyte.

In addition, when the degassing unit 210 includes three or more tanks, the controller 110 may control operations 601 to 605 to be sequentially performed for each of the three or more tanks according to a preset order. Thereafter, the controller 110 may control to repeatedly perform the injection process from operation 607 to operation 613 by discharging the electrolyte degassed in each tank to the electrolyte transfer line according to the preset order.

According to various embodiments, as described with reference to FIGS. 4 and 5, the control valve 471 which is a 3-way valve may be configured in the hopper line between the first hopper 261-2 and the second hopper 263, and the nitrogen supply line 25-3 may be connected to the control valve 471. At this time, the controller 110 may pressurize the second hopper 263 with nitrogen (operation 801) while the electrolyte in the second hopper 263 is injected into the cell 251.

For example, the controller 110 may perform nitrogen pressurization on the second hopper 263 from operation 609 of transferring the electrolyte in the first hopper 261-2 to the second hopper 263.

According to an embodiment, the controller 110 may control the control valve 471 such that the nitrogen introduced through the nitrogen supply line 25-3 is transferred to the second hopper 263 while the electrolyte is transferred from the first hopper 261-2 to the second hopper 263.

However, the controller 110 may block a flow of the electrolyte between the first hopper 261-2 and the second hopper 263, and control the control valve 471 such that the nitrogen introduced through the nitrogen supply line 25-3 is transferred to the second hopper 263.

Thereafter, the controller 110 may terminate the nitrogen pressurization on the second hopper 263 (e.g., control the control valve 471 to block a flow of nitrogen between the nitrogen supply line 25-3 and the second hopper 263) depending on settings or when the injection of the electrolyte into the cell 251 is completed (operation 613).

The controller 110 may terminate the embodiment of FIG. 6 upon performing the operation of operation 613.

According to the above-described embodiments, the method and apparatus for injecting an electrolyte based on degassing may perform a degassing process before injecting the electrolyte, thereby removing a dissolved gas in the electrolyte to minimize bubble formation that may occur inside a battery cell. Through this, it is possible to prevent performance degradation of the battery cell by allowing the electrolyte to diffuse uniformly within the cell, and to reduce contact resistance between an electrode and the electrolyte.

According to various embodiments, the method and apparatus for injecting an electrolyte based on degassing may monitor a state of the electrolyte before and after injection in real time and precisely control a pressure change during an injection process, thereby enabling uniform filling of the electrolyte. Through this, it is possible to prevent scattering due to an excessive pressure difference during the injection of the electrolyte, and to prevent performance degradation of the battery that may occur due to non-uniform filling of the electrolyte.

According to various embodiments, the method and apparatus for injecting an electrolyte based on degassing may precisely adjust a pressure balance between the first hopper and the second hopper during the injection process of the electrolyte, so that the electrolyte may be stably injected into the cell at a constant flow rate. Through this, it is possible to minimize turbulence and air mixing that may occur during the injection process of the electrolyte, thereby maintaining uniform filling inside the cell and improving long-term performance stability of the battery.

In addition, according to various embodiments, the method and apparatus for injecting an electrolyte based on degassing may combine a method of injecting the electrolyte in a vacuum environment and a method of injecting the electrolyte using nitrogen pressurization, thereby maximizing flexibility of a battery manufacturing process. Through this, it is possible to select an optimal electrolyte injection method according to process conditions, improve efficiency of the battery manufacturing process, and consistently maintain product quality.

The contents described above are merely examples applying the principles of the present disclosure, and other configurations may be further included without departing from the scope of the present disclosure. For example, at least some of the various embodiments of the present disclosure described above may be combined.

What is claimed is:

1. A method for injecting an electrolyte based on degassing, comprising:
depressurizing a tank into which an electrolyte is injected to a first pressure;
transferring, by pressurizing the tank to a second pressure with nitrogen in the depressurized state, the nitrogen-pressurized electrolyte to a first hopper;
transferring the nitrogen-pressurized electrolyte to a second hopper inside a chamber depressurized to a third pressure;
increasing a pressure inside the chamber to a fourth pressure equal to or higher than an atmospheric pressure;
completing injection of the electrolyte into a cell inside the chamber; and
heating the electrolyte in the tank or the first hopper to a target temperature based on vapor pressures of respective components of the electrolyte.

2. The method of claim 1, wherein the target temperature is a temperature set such that a vapor pressure of a component having a highest vapor pressure among components included in the electrolyte is less than the first pressure.

3. The method of claim 1, wherein heating the electrolyte comprises heating the electrolyte to reach the target temperature using a storage container heating method or an electrolyte heating method.

4. The method of claim 1, wherein the second pressure is an atmospheric pressure or a preset value equal to or greater than 100 kPa.

5. The method of claim 1, wherein transferring the nitrogen-pressurized electrolyte to the first hopper comprises transferring the electrolyte in the tank to the first hopper using a metering pump or a mass flow controller.

6. The method of claim 1, wherein increasing the pressure inside the chamber comprises pressurizing the chamber with nitrogen to increase the pressure inside the chamber to a preset fifth pressure exceeding the fourth pressure.

7. The method of claim 1, further comprising:
depressurizing the first hopper to a sixth pressure higher than the third pressure upon completion of the transfer of the electrolyte, prior to transferring the nitrogen-pressurized electrolyte to the second hopper.

8. The method of claim 1, wherein heating the electrolyte comprises controlling the target temperature or a heating time such that a dissolved gas concentration of the electrolyte injected into the tank is equal to or less than a preset value.

9. The method of claim 1, wherein the tank comprises two or more tanks, and
wherein transferring the nitrogen-pressurized electrolyte to the first hopper comprises alternately transferring the electrolyte in the two or more tanks to the first hopper.

10. The method of claim 1, further comprising: pressurizing the second hopper with nitrogen after transferring the nitrogen-pressurized electrolyte to the second hopper inside the chamber depressurized to the third pressure.

11. An apparatus for injecting an electrolyte based on degassing, comprising:
a tank for controlling a temperature and a pressure of an electrolyte;
a first hopper for transferring the electrolyte;
a cell into which the electrolyte is injected;
a chamber for controlling a pressure of the cell;
a second hopper inside the chamber for injecting the electrolyte; and
a controller configured to:
depressurize the tank into which the electrolyte is injected to a first pressure;
transfer, by pressurizing the tank to a second pressure with nitrogen in the depressurized state, the nitrogen-pressurized electrolyte to the first hopper;
transfer the nitrogen-pressurized electrolyte to the second hopper inside the chamber depressurized to a third pressure;
increase a pressure inside the chamber to a fourth pressure equal to or higher than an atmospheric pressure;
complete injection of the electrolyte into the cell inside the chamber; and
heat the electrolyte in the tank or the first hopper to a target temperature based on vapor pressures of respective components of the electrolyte.

12. The apparatus of claim 11, wherein the target temperature is a temperature set such that a vapor pressure of a component having a highest vapor pressure among components included in the electrolyte is less than the first pressure.

13. The apparatus of claim 11, wherein the controller is configured to heat the electrolyte to reach the target temperature using a storage container heating method or an electrolyte heating method.

14. The apparatus of claim 11, wherein the second pressure is an atmospheric pressure or a preset value equal to or greater than 100 kPa.

15. The apparatus of claim 11, wherein the controller is configured to transfer the electrolyte in the tank to the first hopper using a metering pump or a mass flow controller.

16. The apparatus of claim 11, wherein the controller is configured to pressurize the chamber with nitrogen to increase the pressure inside the chamber to a preset fifth pressure exceeding the fourth pressure.

17. The apparatus of claim 11, wherein the controller is configured to depressurize the first hopper to a sixth pressure higher than the third pressure upon completion of the transfer of the electrolyte.

18. The apparatus of claim 11, wherein the controller is configured to control the target temperature or a heating time such that a dissolved gas concentration of the electrolyte injected into the tank is equal to or less than a preset value.

19. The apparatus of claim 11, wherein the tank comprises two or more tanks, and wherein the controller is configured to alternately transfer the electrolyte in the two or more tanks to the first hopper.

20. The apparatus of claim 11, wherein the controller is configured to pressurize the second hopper with nitrogen after transferring the nitrogen-pressurized electrolyte to the second hopper inside the chamber depressurized to the third pressure.
